(19) United States
(12) Patent Application Publication
(10) Pub. No.: US 2004/0097275 A1
(43) Pub. Date: May 20, 2004

(54) Cordless telephone

(75) Inventors: Hiroki Ohno, Tokyo (JP); Fumiya Hirayama, Tokyo (JP)

Correspondence Address: MORGAN LEWIS & BOCKIUS LLP, 1111 PENNSYLVANIA AVENUE NW, WASHINGTON, DC, 20004, US

(73) Assignee: Uniden Corporation

(21) Appl. No.: 10/338,897

(22) Filed: Jan. 9, 2003

(30) Foreign Application Priority Data
Nov. 20, 2002 (JP) 2002-336537

(51) Int. Cl. H04M 1/00

(52) U.S. Cl. 455/572; 455/573

(57) ABSTRACT

The object of the present invention is to simplify the circuit configuration of a charge system in a cordless phone. For this object, a stationary device in the cordless telephone in accordance with the present invention is provided with a power source circuit for charging a secondary battery contained in a mobile device. The mobile device comprises a charge switch unit for continuously conducting ON/OFF of the charge current supplied from the power source circuit to the secondary battery and controlling a pulse-waveform charge current, and a switch control unit for adjusting the duty ratio of the pulse waveform and adjusting the average value of the charge current supplied to the secondary battery by controlling the ON/OFF time of the charge current in the charge switch unit.

### BACKGROUND OF THE INVENTION

1. Field of the Invention

The present invention relates to the improvement of cordless telephones provided with a charging function.

2. Description of the Related Art

U.S. Pat. No. 5,677,944 disclosed a technology for preventing overcharging or insufficient charging of a mobile device from a stationary device in a cordless telephone, this technology comprising the steps of measuring the usage quantity of a secondary battery in the mobile device, calculating the charge quantity necessary for full charging, and then controlling the charge current. FIG. 9 illustrates schematically a charge system comprising as the main component a change-over switch for switching a charge current in the cordless telephone disclosed in the aforesaid reference. A change-over switch 60 is used to switch the charge current supplied from a power source circuit 50 of a stationary device to an appropriate value according to the charge mode (normal/fast) and to supply the current to a secondary battery 70 of a mobile device and is composed of a plurality of resistors 60b-60d of different resistivity and a switch 60a for switching the circuit path to any of resistors 60b-60d. FIG. 10 shows an example of means alternative to change-over switch 60, this means being composed of a resistor 60e and resistor 60f connected in series, a transistor 60g with an emitter terminal and a collector terminal connected in parallel with the resistor 60e, and a resistor 60h connected to the base terminal of transistor 60g. Switch controlling the transistor 60g and ON/OFF controlling the current through resistor 60e enable providing a plurality of current paths corresponding to the charge mode.

However, if a plurality of charge paths are provided as shown in FIG. 9 and FIG. 10, the scale of charge circuit of the mobile device is increased and the product cost is raised. It is needless to say that cost has to be reduced to expand the use of cordless telephones. Another problem associated with the conventional cordless telephones was that if a mobile device was set in the prescribed position on a stationary device, the mobile device was charged automatically, the mobile device had to be charged even in the middle of power consumption by the stationary device using the speakerphon function or answering machine function, and power source load of the stationary device became excessive.

### SUMMARY OF THE INVENTION

It is an object of the present invention to provide a charge control technology suitable for cordless telephones.

Another object of the present invention is to reduce the cost of cordless telephones by simplifying the charge circuit of a mobile device.

Another object of the present invention is to provide a system with good power consumption efficiency in which charging of a mobile device is conducted by a stationary device.

In order to attain the above-described objects, in the cordless telephone in accordance with the present invention, which is composed of a stationary device and a mobile device, the stationary device comprises a power source circuit for charging a secondary battery contained in said mobile device, and the mobile device comprises a charge switch unit for continuously conducting ON/OFF of the charge current supplied from the power source circuit to the secondary battery and outputting a pulse-waveform charge current, and a switch control unit for adjusting the duty ratio of the pulse waveform and adjusting the average value of the charge current supplied to the secondary battery by controlling the ON/OFF time of the charge current in the charge switch unit. With such a configuration, providing the charge switch unit for continuously conducting ON/OFF of the charge current supplied to the secondary battery makes it unnecessary to provide a plurality of current systems and simplifies the charge circuit of the mobile device.

The switch control unit preferably adjusts the duty ratio of the pulse waveform according to a charge mode. Making the duty ratio of the charge current changeable between that during normal charging and that during fast charging allows the average value of the charge current corresponding to the charge mode to be adjusted.

The switch control unit preferably adjusts the duty ratio of the pulse waveform so that said charge current becomes a trickle current if the secondary battery is fully charged. With such a configuration, overcharge of the secondary battery can be prevented.

The charge switch unit preferably comprises a three-terminal transistor in which a collector terminal and an emitter terminal are input/output terminals for the charge current and which is ON/OFF controlled by a base potential. With such a configuration, ON/OFF control of charge current can be conducted with one transistor and circuit configuration can be simplified.

The cordless telephone in accordance with the present invention is composed of a stationary device and a mobile device, wherein the stationary device comprises a power source circuit for charging a secondary battery contained in the mobile device, a modulation unit for continuously conducting ON/OFF of a charge current output from the power source circuit and outputting a pulse-like modulated current, and a modulation control unit for controlling the modulation unit so as to output the modulated current when power consumption in the stationary device exceeds the prescribed value determined in advance, and the mobile device comprises charge limiting means for limiting charging of the secondary battery from the power source circuit when the modulated current output from the modulation unit has been detected. With such a structure, when power consumption in the stationary device is large, the power supply to the mobile device can be temporarily terminated and charge control can be conducted at the stationary device. As a result, a system with good power consumption efficiency can be designed.

The cordless telephone in accordance with the present invention is composed of a stationary device and a mobile device, wherein the stationary device comprises a power source circuit for charging a secondary battery contained in the mobile device and a charge control unit for outputting a control signal requiring charge limitation to the mobile device via a control system provided as a system separate from the charge system provided between the stationary device and mobile device, when power consumption of the stationary device exceeds the prescribed value determined in advance, and the mobile device comprises charge limiting means for limiting charging of the secondary battery from the power source circuit when the control signal output from the charge control unit has been detected. With such a structure, when power consumption of the stationary device is large, the power supply to the mobile device can be temporarily terminated by transmitting the charge limiting signal to the mobile device via the control system provided as a system separate from the charge system and charge control can be conducted at the stationary device. As a result, a system with good power consumption efficiency can be designed.

The cordless telephone in accordance with the present invention is composed of a stationary device and a mobile device, wherein the stationary device comprises a power source circuit for charging a secondary battery contained in the mobile device, a wireless unit for wireless communication with the mobile device, and a charge control unit for outputting a control signal requiring charge limitation to the mobile device via the wireless unit when power consumption in the stationary device exceeds the prescribed value determined in advance, and the mobile device comprises charge limiting means for limiting charging of the secondary battery from the power source circuit when the control signal output from the wireless unit has been detected.

With such a structure, when power consumption of the stationary device is large, the power supply to the mobile device can be temporarily terminated by transmitting the charge limiting signal to the mobile device via the wireless circuit and charge control can be conducted at the stationary device. As a result, a system with good power consumption efficiency can be designed.

### BRIEF DESCRIPTION OF THE DRAWINGS

FIG. 1 is a schematic structural diagram of the charge system of the cordless telephone of the present embodiment;

FIG. 2 is a circuit diagram of a switch unit of the present embodiment;

FIG. 3 is another circuit diagram of a switch unit of the present embodiment;

FIG. 4 is a timing chart of various units of the system in a charge mode;

FIG. 5 is a timing chart of various units of the system in a charge termination mode;

FIG. 6 is flow chart representing the charge control processing;

FIG. 7 is a schematic structural diagram of the charge system of the cordless telephone of the second embodiment of the present invention;

FIG. 8 is a schematic structural diagram of the charge system of the cordless telephone of the third embodiment of the present invention;

FIG. 9 is a schematic structural diagram of the charge system in the conventional cordless telephone; and

FIG. 10 is a schematic structural diagram of the charge system in the conventional cordless telephone.

### DESCRIPTION OF THE PREFERRED EMBODIMENTS

### Embodiment 1

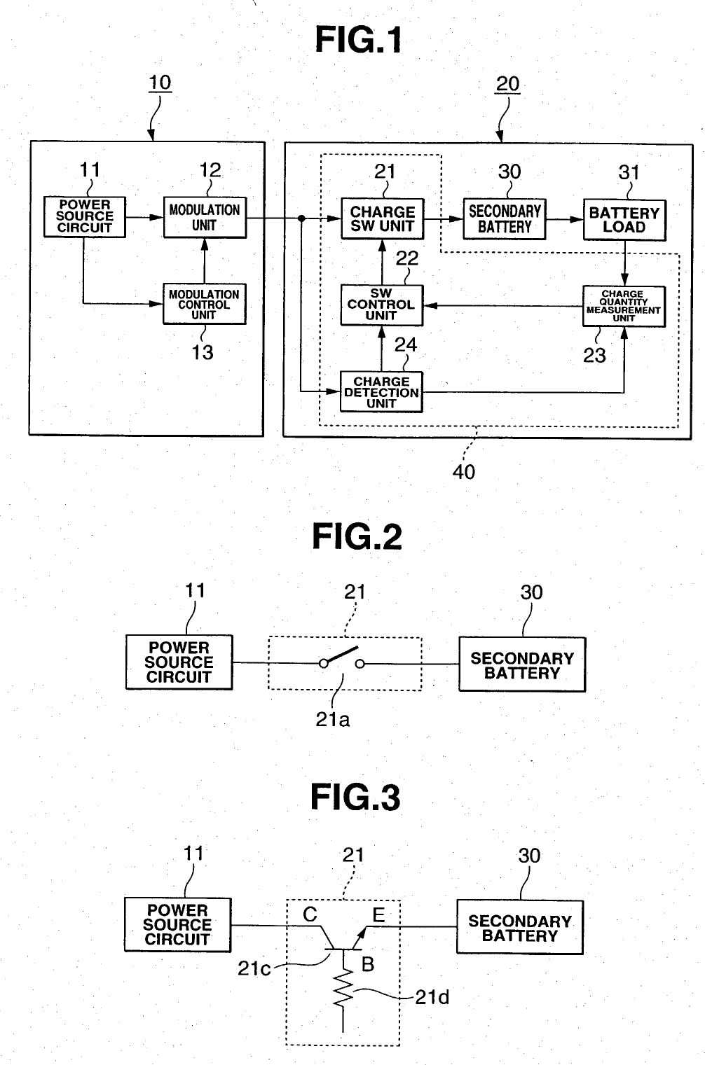

FIG. 1 is a block diagram illustrating schematically the charge system of the cordless telephone of the present embodiment. As shown in the figure, the cordless telephone comprises a stationary device 10 for conducting transmission and reception of voice signals via a telephone line and a mobile device 20 that can be wireless connected to the stationary device 10. The stationary device 10 comprises a power source circuit (electric current source) 11 for charging a secondary battery 30 contained in the mobile device 20, a modulation unit 12 for continuously conducting ON/OFF of a direct current supplied from the power source circuit 11 and outputting the modulated current that was modulated to have a pulse-like shape to the mobile device 20, and a modulation control unit 13 for controlling the modulation unit 12 so that the modulated current is output in the modulation unit 12 when power consumption in the stationary device 10 exceeds the prescribed value determined in advance. The modulation unit 12 is composed of a switching element such as a transistor or the like. Modulation of charge current in the modulation unit 12 is conducted when power consumption in the stationary device 10 increases; no modulation of charge current in the modulation unit 12 is conducted in a charge mode.

The mobile device 20 comprises a charge circuit 40 composed of a charge switch unit 21, a switch control unit 22, a charge quantity measurement unit 23, and a charge detection unit 24, and a battery load 31. In addition, the mobile device 20 has a structure allowing for detachable mounting of a secondary battery 30. If the mobile device 20 is set in the prescribed position on the stationary device 10, the terminals of the charge systems of the two units are connected and the stationary device 10 charges the mobile device 20 automatically. The secondary battery 30 is preferably a lithium battery, a nickel-cadmium battery, a nickel-hydrogen battery, and the like. The charge switch unit 21 continuously and with prescribed timing conducts ON/OFF of the DC charge current supplied from the power source circuit 11 and supplies the charge current with pulse waveform adjusted to the prescribed duty ratio to the secondary battery 30. The average value of the charge current supplied to the secondary battery 30 can be increased or decreased by adjusting the duty ratio of the pulse waveform. The duty ratio of the pulse waveform adjusted by the charge switch unit 21 differs depending on the charge mode, and the average value of the charge current per unit time, which is supplied to the secondary battery 30, can be adjusted by setting the duty ratio so that the duty ratio of the pulse waveform for a fast charge mode is larger than the duty ratio of the pulse waveform for a normal charge mode.

FIG. 2 illustrates an example of specific circuit configuration of charge switch unit 21; in this example, the unit is composed of a switching element 21a conducting ON/OFF of the charge current. The duty ratio of pulse waveform can be randomly adjusted by adjusting the ON/OFF timing of switching element 21a, that is, the ON/OFF time of the charge current. FIG. 3 shows an example of alternative means for the charge switch unit 21, this means being composed of a three-terminal transistor 21c. The collector terminal (current input terminal) of the transistor is connected to the power source circuit 11, whereas the emitter terminal (current output terminal) is connected to the secondary battery 30. Further, a resistor 21d is connected to the base terminal of the transistor. Controlling the base potential of the transistor makes it possible to ON/OFF control the transistor and adjust the duty ratio of pulse waveform.

Returning to FIG. 1, the explanation of the configuration of various units of mobile device 20 will be continued below. The battery load 31 is a general name for various devices consuming the power of secondary battery 30, such as a wireless unit, a display, and the like. The charge quantity measurement unit 23 converts the battery usage quantity of secondary battery 30 into numerical values and digitally measures this quantity. The battery usage quantity is obtained by quantitatively converting the usage time of secondary battery 30 into numerical values and is almost equal to the talking time of mobile device 20. For example, if the mobile device 20 is activated and the power of secondary battery 30 is consumed, the battery usage quantity is increased by one point per the prescribed unit time. Because the battery usage quantity is thus counted up by one point, in the present specification the battery usage quantity and count value are employed in the same sense. On the other hand, when the secondary battery 30 is charged, the battery usage quantity is decreased by one point per the prescribed unit time and the count value is counted down. As for subtraction of count values during charging, the point value deducted per unit time can be appropriately set according to the charging mode, for example, so that countdown is conducted by one point during normal charge, whereas during fast charge, it is conducted by three points. If the battery usage quantity is thus measured, the current supply quantity necessary to charge the secondary battery 30 can be understood at the mobile device 20 and overcharge can be prevented.

The charge detection unit 24 checks the presence of charge current supply from the power source circuit 11 and the duty ratio of the charge current by monitoring the terminal voltage of the charge system of the cordless telephone. When the electric current signal supplied from the stationary device 10 has been detected, the charge detection unit 24 checks as to whether the electric current signal is a DC signal or a pulse modulated signal. In the present embodiment, when the charge current supplied to the mobile device 20 from the stationary device 10 is a DC current, the transition of the system to a charge mode is indicated, and when the charge current supplied to the mobile device 20 from the stationary device 10 is a modulated current, the transition of the system to a charge termination mode is indicated. If the charge detection unit 24 detects the DC current, it sends a charge mode transition notification, which indicates the transition of the system to the charge mode, to the charge quantity measurement unit 23. The charge quantity measurement unit 23 that has received the charge mode transition notification sequentially counts down the count value according to the charge mode (whether a normal charge mode or a fast charge mode) and the charge time. The switch control unit 22 controls ON/OFF of the charge current in the charge switch unit 21 according to the charge mode and also controls the duty ratio of the pulse waveform so as to supply a trickle current to the secondary battery 30 if the count value in the charge quantity measurement unit 23 becomes 0 and the secondary battery 30 is fully charged. The charge mode of the secondary battery 30 with the trickle current is called a trickle charge mode or an intermittent charge mode.

On the other hand, if the charge detection unit 24 detects the modulated current, it is decided that the system makes a transition to a charge termination mode and a hold signal requesting that the countdown of the count value in the charge quantity measurement unit 23 be temporarily terminated (count hold) is output to the charge quantity measurement unit 23. The charge quantity measurement unit 23 that has received the hold signal holds the count value till the charge termination mode is cancelled. Furthermore, in the charge switch unit 21, switching control is conducted so that the charge current is interrupted and no charge current is supplied to the secondary battery 30.

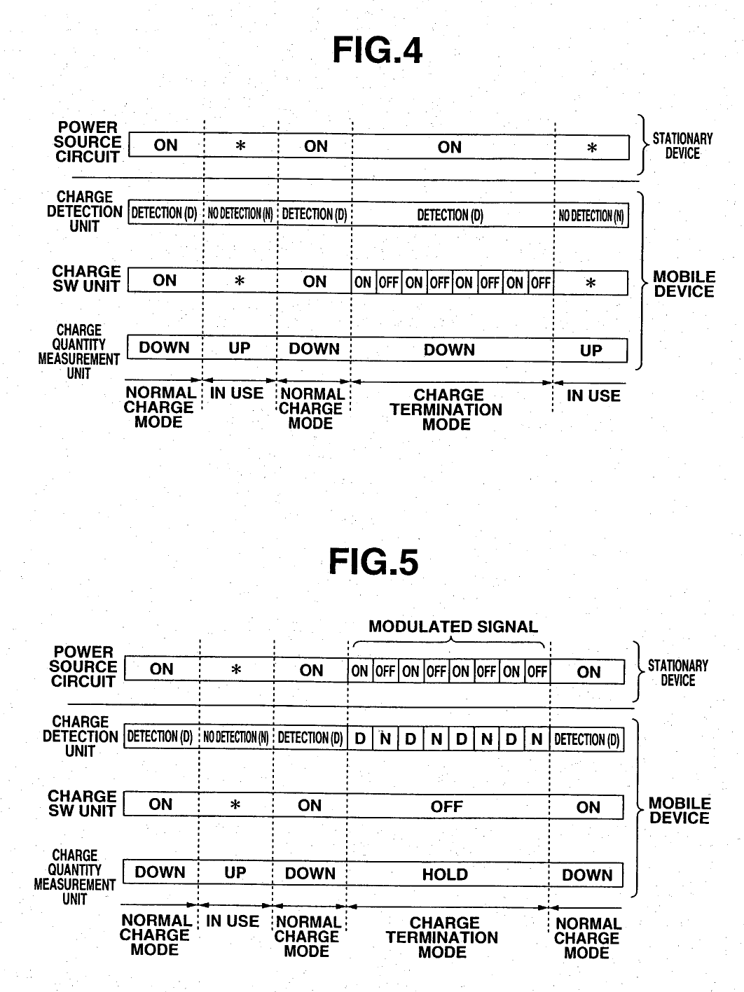

FIG. 4 is a timing chart illustrating the operation of various units in the state in which the system has made a transition to the charge mode. As shown in the figure, during normal charging, the supply of the charge current from the power source circuit 11 is ON, the supply of the DC charge current is detected in the charge detection unit 24, and the electric current supply assumes an ON state in the charge switch unit 21. The electric current quantity measurement unit 24 counts down the count value according to the charge mode and charge time. On the other hand, when the mobile device 20 is used, the charge quantity measurement unit 23 counts up the count value. In the figure, the symbol “*” indicates that any of ON and OFF is allowed. If the secondary battery 30 is fully charged, the charge switch unit 21 conducts ON/OFF of the charge current and intermittent charge by a trickle current.

FIG. 5 is a timing chart illustrating the operation of various units in the state in which the system has made a transition to the charge termination mode. Explanation of the points common with those explained with reference to FIG. 4 is omitted. In a state in which the stationary device 10 uses a speakerphon function or answering machine function and consumes a large quantity of electric power, power supply to the mobile device 20 becomes an excess load for the stationary device 10. Accordingly, the stationary device 10 activates the modulation unit 12 and modulates the charge current, thereby notifying that the system has made a transition to a charge termination mode. If the charge detection unit 24 detects the modulated current, the supply of charge current in the charge switch unit 21 is interrupted and a count value in the charge quantity measurement unit 23 is held.

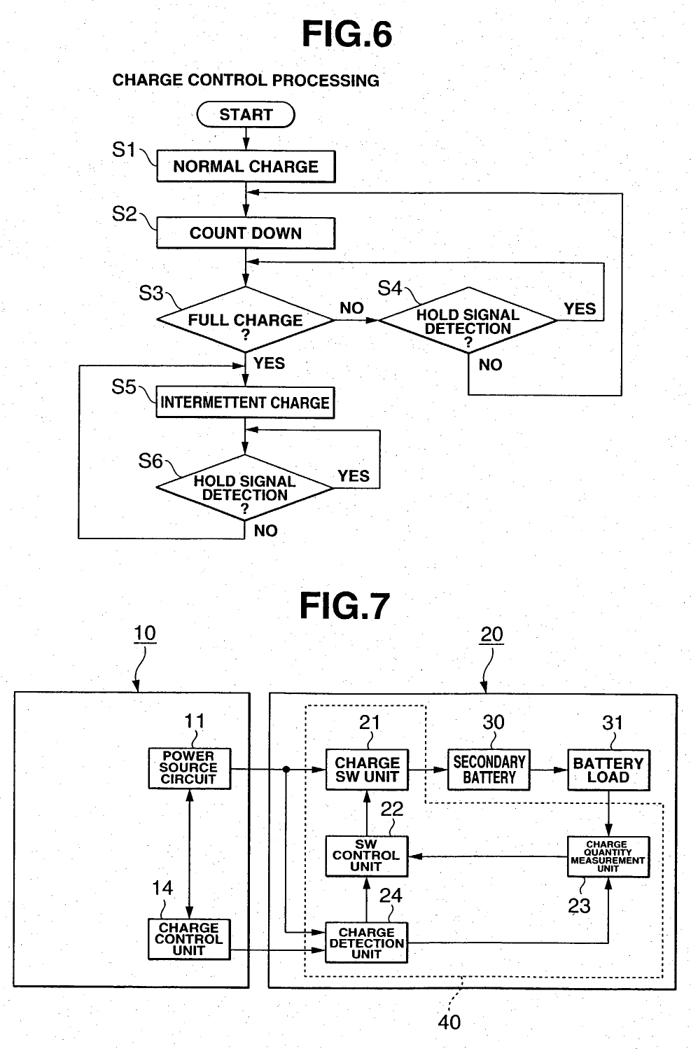

FIG. 6 is a flow chart representing the charge control processing in the cordless telephone of the present embodiment. If the mobile device 20 is set in the prescribed position on the stationary device 10, the mobile device 20 is charged from the stationary device 10 (step S1). In this case, normal charging is assumed, but switching to fast charging may be conducted by manual operation. If the mobile device 20 is charged, the count value is counted down correspondingly to the charge mode and charge time (step S2). The charge quantity measurement unit 23 checks the count value and decides as to whether the secondary battery 30 has been fully charged, that is, whether the count value has become 0 (step S3). When the secondary battery 30 has not been fully charged (step S3; NO) and the charge quantity measurement unit 23 has not detected the hold signal (step S4; NO), the program returns to step S2, count down is conducted, and a loop is formed between the step S2 and step S4. If the charge quantity measurement unit 23 detects the hold signal (step S4; YES), the program is pulled out from the loop, moves to step S3, and terminates the countdown.

On the other hand, if in the charge quantity measurement unit 23 the count value becomes 0 and the secondary battery 30 is fully charged (step S3; YES), a transition to a trickle charge mode is made, the duty ratio of the pulse waveform of charge current is decreased, and intermittent charging is conducted (step S5). In this state, if the charge quantity measurement unit 23 detects the hold signal (step S6; YES), the intermittent charging is terminated and the program again returns to step S6. When the charge quantity measurement unit 23 has not detected the hold signal (step S6; NO), the intermittent charging is conducted continuously (step S5).

Thus, in the present embodiment, a configuration is used in which a charge switch unit 21 capable of randomly adjusting the duty value of pulse waveform is provided as means (current quantity adjustment means) for switching the average charge current supplied from the stationary device 10 to the mobile device 20. Therefore, it is not necessary to provide a plurality of current paths in advance and the charge circuit 40 of mobile device 20 can be simplified. As a result, cost reduction of the cordless telephone can be realized. Furthermore, if power consumption in the stationary device 10 is increased and sufficient charge current cannot be supplied to the mobile device 20, a modulated current is supplied from the stationary device 10 to the mobile device 20, the charge current in the mobile device 20 is interrupted, and the count value is temporarily held. Therefore, charge control at the stationary device is possible and a system with good power consumption efficiency can be designed.

### Embodiment 2

FIG. 7 is a block diagram of the cordless telephone of the second embodiment of the present invention. In this figure, reference symbols identical to those in FIG. 1 are assigned to identical components and explanation thereof is omitted. A stationary device 10 comprises a power source circuit 11 for charging a secondary battery 30 contained in a mobile device 20 and a charge control unit 14 for conducting charge control of the mobile device 20. A power source system with two terminals designed specifically for charging is formed between the power source circuit 11 and a charge switch unit 21. Charge control from the stationary device 10 to the mobile device 20 is conducted via a control system using a third terminal provided between the charge control unit 14 of stationary device 10 and a charge detection unit 24 of mobile device 20, as a system separate from the above-mentioned two-terminal power source system. If the stationary device 10 uses a speakerphon function or an answering machine function, the power consumption in the stationary device 10 increases. When power consumption in the stationary device 10 exceeds the predetermined value, the charge control unit 14 outputs a control signal requiring charge termination, via the third terminal. If the charge detection unit 24 detects this control signal, it controls the switch control unit 22 so as to conduct current interruption in the charge switch unit 21 and also controls the charge quantity measurement unit 23 into a count hold state. With such a configuration, when power consumption in the stationary device 10 is large, the supply of power to the mobile device 20 can be temporarily terminated and charge control can be conducted at the stationary device. As a result, a system with good power consumption efficiency can be designed.

### Embodiment 3

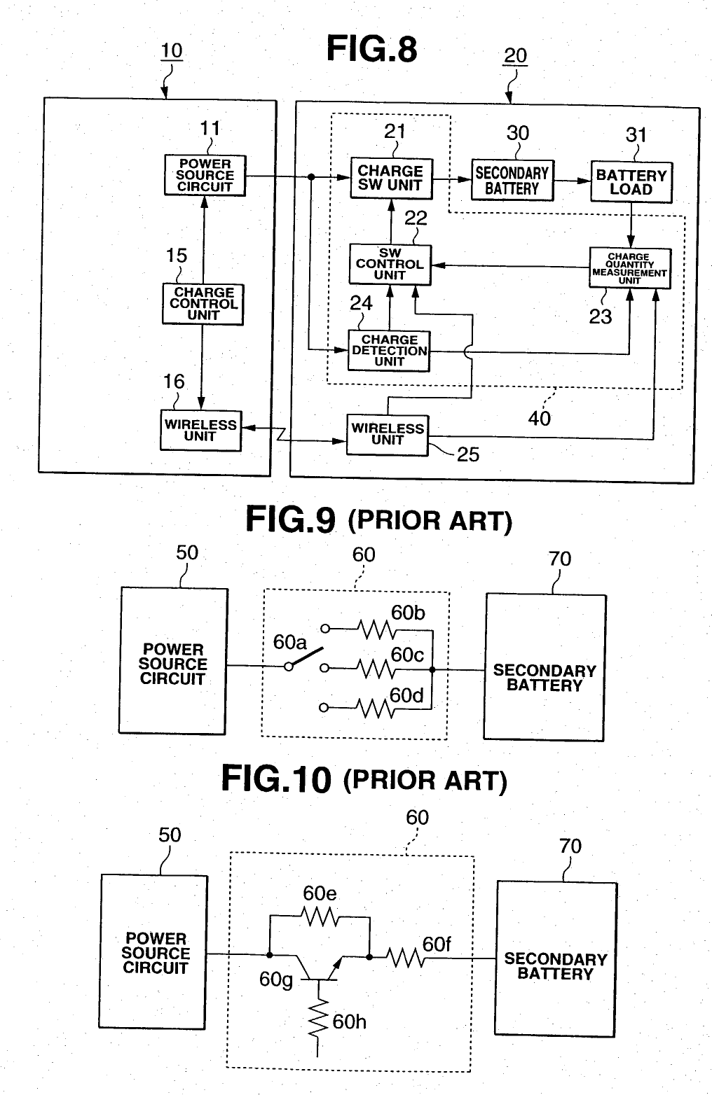

FIG. 8 is a block diagram of the cordless telephone of the third embodiment of the present invention. In this figure, reference symbols identical to those in FIG. 1 are assigned to identical components and explanation thereof is omitted. A stationary device 10 comprises a power source circuit 11 for charging a secondary battery 30 contained in a mobile device 20, a charge control unit 15 for conducting charge control of the mobile device 20, and a wireless unit 16 for conducting wireless communication with the mobile device 20. On the other hand, the mobile device 20 has a configuration shown in FIG. 1 and additionally comprises a wireless unit 25 for conducting wireless communication with the stationary device 10. Charge control from the stationary device 10 to the mobile device 20 is conducted by wireless communication between the wireless unit 16 and wireless unit 25, as a system separate from the power source system between the power source circuit 11 and charge switch unit 21. If the stationary device 10 uses a speakerphon function or an answering machine function, power consumption in the stationary device 10 increases. When power consumption in the stationary device 10 exceeds the predetermined value, the charge control unit 15 outputs a control signal requiring charge termination to the wireless unit 25 via the wireless unit 16. If the wireless unit 25 detects this control signal, it controls the switch control unit 22 so as to conduct current interruption in the charge switch unit 21 and also controls the charge quantity measurement unit 23 into a count hold state. With such a configuration, when power consumption in the stationary device 10 is large, the supply of power to the mobile device 20 can be temporarily terminated and charge control can be conducted at the stationary device. As a result, a system with good power consumption efficiency can be designed.

What is claimed is:

1. A cordless telephone composed of a stationary device and a mobile device, wherein:
said stationary device comprises a power source circuit for charging a secondary battery contained in said mobile device; and
said mobile device comprises:
a charge switch unit for continuously conducting ON/OFF of the charge current supplied from said power source circuit to said secondary battery and controlling a pulse-waveform charge current; and
a switch control unit for adjusting the duty ratio of said pulse waveform and adjusting the average value of the charge current supplied to said secondary battery by controlling the ON/OFF time of the charge current in said charge switch unit.

2. The cordless telephone according to claim 1, wherein said switch control unit adjusts the duty ratio of said pulse waveform according to a charge mode.

3. The cordless telephone according to claim 1, wherein said switch control unit adjusts the duty ratio of said pulse waveform so that said charge current becomes a trickle current if said secondary battery is fully charged.

4. The cordless telephone according to claim 2, wherein said switch control unit adjusts the duty ratio of said pulse waveform so that said charge current becomes a trickle current if said secondary battery is fully charged.

5. The cordless telephone according to claim 1, wherein said charge switch unit comprises a three-terminal transistor in which a collector terminal and an emitter terminal are input/output terminals for said charge current and which is ON/OFF controlled by a base potential.

6. The cordless telephone according to claim 2, wherein said charge switch unit comprises a three-terminal transistor which has a collector terminal and an emitter terminal respectively serving as input/output terminals for said charge current and which is ON/OFF controlled by a base potential.

7. The cordless telephone according to claim 3, wherein said charge switch unit comprises a three-terminal transistor which has a collector terminal and an emitter terminal respectively serving as input/output terminals for said charge current and which is ON/OFF controlled by a base potential.

8. A cordless telephone composed of a stationary device and a mobile device, wherein:
said stationary device comprises:
a power source circuit for charging a secondary battery contained in said mobile device;
a modulation unit for continuously conducting ON/OFF of the charge current output from said power source circuit and outputting a pulse-modulated electric current; and
a modulation control unit for controlling said modulation unit so as to output said modulated current when power consumption in said stationary device exceeds the prescribed value determined in advance; and
said mobile device comprises:
charge limiting means for limiting charging of said secondary battery from said power source circuit when the modulated current output from said modulation unit has been detected.

9. A cordless telephone composed of a stationary device and a mobile device, wherein:
said stationary device comprises:
a power source circuit for charging a secondary battery contained in said mobile device; and
a charge control unit for outputting a control signal requiring charge limitation to said mobile device via a control system provided as a system separate from the charge system provided between said stationary device and mobile device, when power consumption of said stationary device exceeds the prescribed value determined in advance; and
said mobile device comprises:
charge limiting means for limiting charging of said secondary battery from said power source circuit when said control signal output from said charge control unit has been detected.

10. A cordless telephone composed of a stationary device and a mobile device, wherein:
said stationary device comprises:
a power source circuit for charging a secondary battery contained in said mobile device;
a wireless unit for conducting wireless communication with said mobile device; and
a charge control unit for outputting a control signal requiring charge limitation to said mobile device via said wireless unit when power consumption of said stationary device exceeds the prescribed value determined in advance; and
said mobile device comprises:
charge limiting means for limiting charging of said secondary battery from said power source circuit when said control signal output from said wireless unit has been detected.
